(19) United States
(12) Patent Application Publication
(10) Pub. No.: US 2008/0046910 A1
(43) Pub. Date: Feb. 21, 2008

(54) METHOD AND SYSTEM FOR AFFECTING PERFORMANCES

(75) Inventors: CHARLES P. SCHULTZ, NORTH MIAMI BEACH, FL (US); JORGE L. PERDOMO, BOCA RATON, FL (US); VON A. MOCK, BOYNTON BEACH, FL (US)

Correspondence Address: AKERMAN SENTERFITT, P.O. BOX 3188, WEST PALM BEACH, FL, 33402-3188, US

(73) Assignee: MOTOROLA, INC., SCHAUMBURG, IL (US)

(21) Appl. No.: 11/461,261

(22) Filed: Jul. 31, 2006

(51) Int. Cl. H04N 5/445; H04N 7/173; H04N 7/16; G06F 13/00; H04H 9/00; G06F 3/00; H04H 60/33; H04H 60/56

(52) U.S. Cl. 725/12; 725/24; 725/10; 725/37; 725/105

(57) ABSTRACT

A system (200) and method (400) for affecting a performance (210) is provided. During the performance, a plurality of audience evaluations can be received (310), the plurality of audience evaluations can be associated with the performance (320), and a sensory aspect of the performance can be adjusted (330) in accordance with the plurality of audience evaluations. The method can include capturing a plurality of sensory actions from multiple devices (160) handled in an audience, generating a plurality of evaluations from the plurality of sensory actions, and identifying a collective audience assessment of the performance from the plurality of sensory actions.

### FIELD OF THE INVENTION

The present invention relates to sensing devices, and more particularly, to methods for affecting the performance of music and other forms of entertainment.

### BACKGROUND

The use of portable electronic devices and mobile communication devices has increased dramatically in recent years. Mobile devices are capable of establishing communication with other communication devices over landline networks, cellular networks, and, recently, wide local area networks (WLANs). Mobile devices are capable of providing access to Internet services which are bringing people closer together in a world of information. Mobile devices operating over a telecommunications infrastructure are capable of providing various forms of multimedia. People are able to collaborate on projects, discuss ideas, interact with one another on-line, all while communicating via text, audio, and video.

In certain public events or forums, people can exchange information using mobile devices. For example, individuals in an audience may communicate with one another via messaging applications. As another example, individuals at home may collaborate with one another through a home audience, on-line, or through collaborative home audio video systems. The messages may be text, audio, or video messages that allow individuals to exchange common interests or ideas. As one example, a person may take a picture, or capture an audio clip, and send it to another person in the audience. This allows individuals to share content and express their interests among one another. In one form, this allows individuals to provide others in the audience their perspective of the public event or forum. However, collaboration is generally limited to the participants in the audience. In certain cases, the common interest shared in the messages may be directed to the public event itself. Moreover, the organizers of the public event may not be capable of addressing individual audience member common interests. Accordingly, a need exists for collaboration that addresses a common interest of the audience members.

### SUMMARY

Embodiments of the invention are directed to a method and system for affecting a performance. The method can include capturing a plurality of sensory actions from multiple devices handled in an audience, generating a plurality of evaluations from the plurality of sensory actions, and identifying a collective audience assessment of the performance from the plurality of sensory actions. During the performance, a plurality of audience evaluations can be received, the plurality of audience evaluations can be associated with the performance, and a sensory aspect of the performance can be adjusted in accordance with the plurality of audience evaluations. In principle, the audience members can collectively cast a vote based on the plurality of audience evaluations to adjust a sensory aspect of the performance. A sensory aspect can include an audio aspect, a video aspect, or a lighting aspect.

In one aspect, the performance can be an auditory experience such that the adjusting changes an equalization of sound produced during the performance. For example, the audience members can collectively equalize an audio performance by generating votes via sensory actions. Audience members can provide the evaluations through sensory actions applied to a handled device. The sensory action may be a depressing action, a squeezing action, a sliding action, or a movement. For example, the sensory actions can adjust a bass, mid-range, and treble of the audio performance. Furthermore, a location and intensity of the depressing action or squeezing action can be identified for adjusting the sensory aspect of the performance in accordance with the location and intensity. For example, audience members can squeeze certain portions of the device to illicit different responses. For instance, the device can be squeezed at the bottom to adjust a bass, squeezed in the middle to adjust a mid-range, and squeezed at the top to adjust a treble. The performance can also include a visual sensory aspect such that the adjusting a lighting of a visual performance can provide an audience wide visual experience. For example, a lighting of a visual performance can be adjusted in response to the vote. The adjusting can change at least one of a lighting, an intensity, an illumination, a color, a pattern, a fog effect, a pyrotechnic effect, or a strobe rate of lighting during the performance.

Embodiments of the invention also concern a system for affecting a performance. The system can include at least one device having, at least one sensor for identifying a sensory action, a processor communicatively coupled to the at least one sensor for associating the sensory action with the performance and producing an evaluation of the performance in response to the sensory action, and a communication unit for transmitting the evaluation. The system can include a media console communicatively coupled to the communication module for receiving a plurality of evaluations from an audience, associating the plurality of evaluations with a sensory aspect of the performance, and adjusting a sensory aspect of the performance in accordance with the plurality of evaluations. The media console may be a centrally controlled system or server that assess the audience evaluations and adjusts an audio, video, or lighting sensory aspect of the performance.

A plurality of mobile devices can capture a plurality of sensory actions continually applied to the plurality of mobile devices during a performance. The plurality of mobile devices can continually generate a plurality of evaluations of the performance based on the plurality of sensory actions, and send the plurality of evaluations during the performance. The sensory actions are audience responses to a sensory aspect of the performance. The media console can receive the plurality of evaluations during the performance, and assess a collective experience of the audience in view of the plurality of evaluations. The media console can associate the plurality of evaluations with a sensory aspect of the performance, and adjust a sensory aspect of the performance in real-time in accordance with the plurality of evaluations. That is, aspects of the performance can be adjusted continually throughout the performance and during the performance.

### BRIEF DESCRIPTION OF THE DRAWINGS

The features of the system, which are believed to be novel, are set forth with particularity in the appended claims. The embodiments herein, can be understood by reference to the following description, taken in conjunction with the accompanying drawings, in the several figures of which like reference numerals identify like elements, and in which:

FIG. 1A is a diagram of a mobile communication environment in accordance with the embodiments of the invention;

FIG. 1B is a diagram for an ad-hoc network of the mobile communication environment of FIG. 1A in accordance with the embodiments of the invention;

FIG. 2 is system for affecting a performance in accordance with the embodiments of the invention;

FIG. 3A is schematic of a mobile device for affecting a performance in accordance with the embodiments of the invention;

FIG. 3B is diagram of the mobile device of FIG. 3A for affecting a performance in accordance with the embodiments of the invention; and

FIG. 4 is a method for affecting a performance in accordance with the embodiments of the invention.

### DETAILED DESCRIPTION

While the specification concludes with claims defining the features of the embodiments of the invention that are regarded as novel, it is believed that the method, system, and other embodiments will be better understood from a consideration of the following description in conjunction with the drawing figures, in which like reference numerals are carried forward.

As required, detailed embodiments of the present method and system are disclosed herein. However, it is to be understood that the disclosed embodiments are merely exemplary, which can be embodied in various forms. Therefore, specific structural and functional details disclosed herein are not to be interpreted as limiting, but merely as a basis for the claims and as a representative basis for teaching one skilled in the art to variously employ the embodiments of the present invention in virtually any appropriately detailed structure. Further, the terms and phrases used herein are not intended to be limiting but rather to provide an understandable description of the embodiment herein.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “processing” or “processor” can be defined as any number of suitable processors, controllers, units, or the like that are capable of carrying out a pre-programmed or programmed set of instructions. The term “performance” can be defined as a musical performance, a theatrical performance, a concert event, a public event, an exposition, or any other suitable event wherein sound production, video production, and lighting production are part of the event. The term “evaluation” can be defined as a response provided by an audience member that reptors, evaluates, or commentates on an aspect of a performance, wherien an aspect can include be audio or visual. The term “sensor” can be defined as a transducer for converting a physical action to an electronic signal. The term “sensory action” can be defined as a physical feedback, a physical response, a physical stimulation, physical action, or physical manipulation applied to a device.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a midlet, a servlet, a source code, an object code, a shared library/dynamic load library and/or other sequence of instructions designed for execution on a computer system. The term “real-time” is defined as occurring during a performance. The term “aspect” is defined as an audio or visual configuration of a performance. The term “evaluation” is defined as a request to change a sensory aspect of a performance. The term “sensory action” is a physical action an audience member applies to a device during a performance. The term “affecting” is to apply one or more changes to a sensory aspect of a performance including aspects of a performance such as scents, motion of floors, walls, objects or motions and vibrations of objects.

Embodiments of the invention are directed to a system and method for affecting a sensory aspect of a performance. Users in an audience can collectively adjust an audio or visual aspect of a performance to cause an audience-wide feedback to produce a desired effect. As an example, audience members can squeeze or depress sensors on a mobile device for adjusting an equalization or lighting of a performance to produce a desired effect. The performance may be a live show and the audience may be people attending the show. Alternatively, the performance may be a televised event and the audience members comprise attendees of the event as well as people watching the event from a home television, or people enrolled on-line watching the event.

The sensory actions are collected and evaluated, and an auditory or visual aspect of the performance can be adjusted in accordance with the collective audience feedback. The audience can collectively determine changes to the performance and a vote can be cast for adjusting the aspect. For instance, a plurality of users can squeeze the mobile device at a particular location for affecting the change. As one example, users can squeeze a bottom of the mobile device to adjust bass content, squeeze the middle to adjust mid-range, and squeeze the top to adjust treble. Notably, a sound aspect of the performance can be adjusted in accordance with audio evaluations provided by the users. Furthermore, the adjustment can be continued throughout the performance to adjust a sensory aspect of the performance for providing dynamic effect.

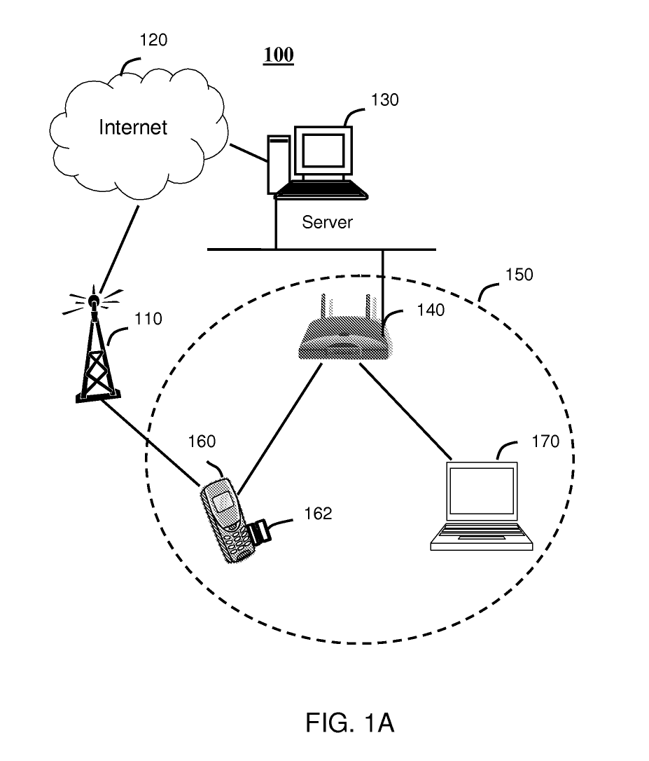

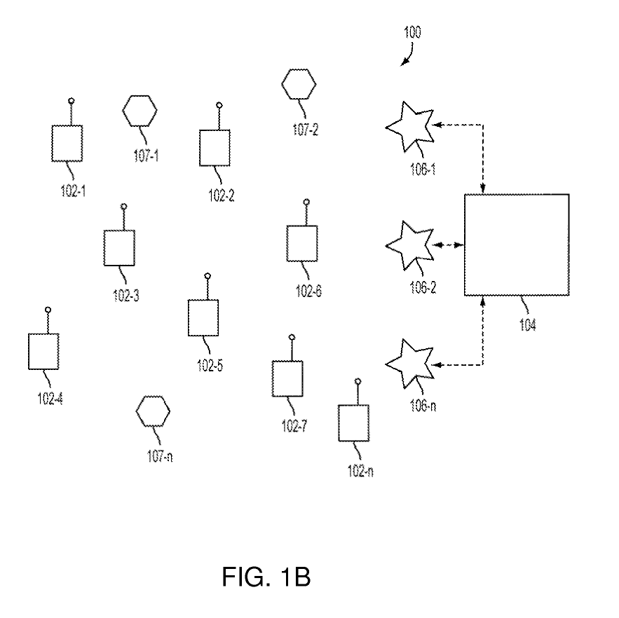

Referring to FIG. 1A, a mobile communication environment 100 is shown. The mobile communication environment 100 can provide wireless connectivity over a radio frequency (RF) communication link or a Wireless Local Area Network (WLAN) link. Briefly, the mobile communication environment 100 provides a foundation supporting audience wide collaboration to affect a performance. Communication within the network 100 can be established using a wireless, copper wire, and/or fiber optic connection using any suitable protocol. In one arrangement, a mobile device 160 can communicate with a base receiver 110 using a standard communication protocol such as TDMA, CDMA, GSM, or iDEN. The base receiver 110, in turn, can connect the mobile device 160 to the Internet 120 over a packet switched link. The Internet 120 can support application services and service layers for providing media or content to the mobile device 160. The mobile device 160 can also connect to other communication devices through the Internet 120 using a wireless communication channel. The mobile device 160 can establish direct connections with a server 130 on the network and with other mobile devices 170 for exchanging data and information. The server can host application services directly, or over the Internet 120.

The mobile device 160 can also connect to the Internet 120 over a WLAN. Wireless Local Access Networks (WLANs) provide wireless access to the mobile communication environment 100 within a local geographical area. WLANs can also complement loading on a cellular system, so as to increase capacity. WLANs are typically composed of a cluster of Access Points (APs) 140 also known as base stations. The mobile communication device 160 can communicate with other WLAN stations such as the laptop 170 within the base station area 150. In typical WLAN implementations, the physical layer uses a variety of technologies such as 802.11b or 802.11g WLAN technologies. The physical layer may use infrared, frequency hopping spread spectrum in the 2.4 GHz Band, or direct sequence spread spectrum in the 2.4 GHz Band. The mobile device 160 can send and receive data to the server 130 or other remote servers on the mobile communication environment 100.

In one example, the mobile device 160 can send and receive data to and from the laptop 170 or other devices or systems over the WLAN connection or the RF connection. The data can include an evaluation for conveying a user's response to a performance. Briefly, the mobile device 160 can be deployed within the communication environment 100 to affect a performance. In particular, the mobile device 160 can include at least one sensor 162 for receiving a response from a user. The user can press the sensor 162 to adjust a sensory aspect of a performance, such as an audio or visual aspect of the performance. For example, during the performance the user can squeeze the mobile device to change an audio equalization or lighting effect of the performance.

The mobile device 160 can be a cell-phone, a personal digital assistant, a portable music player, or any other suitable communication device. The mobile device 160 and the laptop 170 can be equipped with a transmitter and receiver (not shown) for communicating with the AP 140 according to the appropriate wireless communication standard. In one embodiment of the present invention, the wireless station 160 is equipped with an IEEE 802.11 compliant wireless medium access control (MAC) chipset for communicating with the AP 140. IEEE 802.11 specifies a wireless local area network (WLAN) standard developed by the Institute of Electrical and Electronic Engineering (IEEE) committee. The standard does not generally specify technology or implementation but provides specifications for the physical (PHY) layer and Media Access Control (MAC) layer. The standard allows for manufacturers of WLAN radio equipment to build interoperable network equipment.

Referring to FIG. 1B, another aspect of the mobile communication environment 100 for providing peer-to-peer communication in an ad-hoc network is shown. Specifically, a block diagram illustrating an example of an ad-hoc wireless communications network 100 employing an embodiment of the present invention is shown. Ad-hoc networks require the participation of many nodes for providing efficient and optimized networking. Value can be created through cooperative ad-hoc networking capabilities made available by participating nodes. That is, an ad-hoc network relies on the contribution of other nodes within the network to share resource loads, such as forwarding data packets, or messages. Specifically, the network 100 includes a plurality of mobile wireless user terminals 102-1 through 102-n (referred to generally as nodes 102 or mobile nodes 102), and can, but is not required to, include a fixed network 104 having a plurality of access points 106-1, 106-2, . . . 106-n (referred to generally as nodes 106, access points (APs) 106 or intelligent access points (IAPs) 106), for providing nodes 102 with access to the fixed network 104. The fixed network 104 can include, for example, a core local area network (LAN), and a plurality of servers and gateway routers to provide network nodes with access to other networks, such as other ad-hoc networks, the public switched telephone network (PSTN) and the Internet. The network 100 further can include a plurality of fixed routers 107-1 through 107-n (referred to generally as nodes 107, wireless routers (WRs) 107 or fixed routers 107) for routing data packets between other nodes 102, 106 or 107. It is noted that for purposes of this discussion, the nodes discussed above can be collectively referred to as “nodes 102, 106 and 107”, or simply “nodes”.

In another arrangement, the nodes 102-n within the mobile communication environment can communicate via Bluetooth within the ad-hoc network 100. Bluetooth is suitable for short-distance communication and is an industrial specification for wireless personal area networks (PANs), also known as IEEE 802.15.1. Bluetooth provides a way to connect and exchange information between devices like personal digital assistants (PDAs), mobile phones, laptops, PCs, printers, digital cameras and video game consoles. For example, nodes 102-n can communicate amongst one another using Bluetooth communications. In particular, the nodes 102-n can share information through messages concerning aspects of a performance. For example, nodes can share audio or visual information related to one or more aspects of a performance.

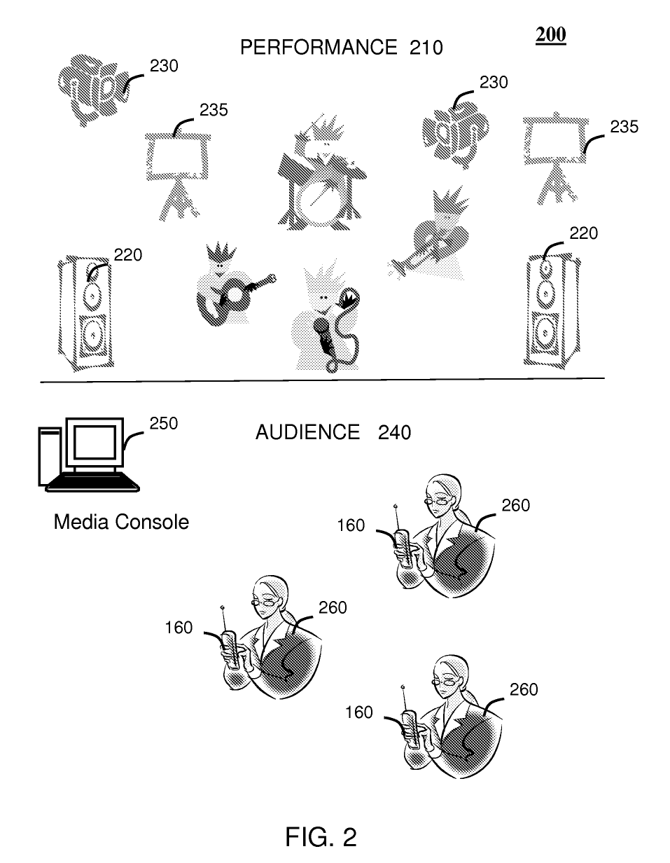

Referring to FIG. 2, a system 200 for affecting a performance is shown. Notably, the mobile communication environment 100 provides the context for an event. For example, the event can comprise a performance 210 and an audience 240. The system 200 can include a sound production system 220, a lighting production system 230, and a visual production system 235. Other systems such as motion, vibration, and olfactory systems or other sensory systems are herein contemplated. For example, a balance of different scents can be adjusted to change the olfactory experience. The system 200 can include a media console 250 and a plurality of mobile devices 160. The mobile devices 160 can communicate one or more audience evaluations to the media console 250. The media console 250 can assess the evaluations and adjust an aspect of the performance 210. The system 220 may have more or less than the number of components shown.

The performance 210 can be a musical performance, a theatrical performance, a concert event, a public event, an exposition, or any other suitable event wherein sound production, video production, and lighting production are part of the event. The performance 210 may also be a televised event that is broadcast to numerous households, institutions, places of meeting, or facilities. The event can also be delivered via satellite, terrestrial wireless systems, AM/FM radio, and the like. The performance 210 may also be broadcast over the internet which may include home entertainment systems, personal computers, or portable media players. The audience 210 includes those individuals attending or watching the performance. The audience 240 may be physically present with the performance 210 or watching the performance 210 on-line, at home, or over a portable media player.

As an example, a musical performance may include performers such as musicians that play musical instruments and sing. The musicians may play one or more electronic or acoustic instruments that can be amplified to produce sound for the audience 240. The sound may also be broadcast or televised to a home audience or on-line audience. Furthermore, the musicians can sing into one or more microphones where their voice can be amplified and presented to the audience 240. In one arrangement, the performance can take place on a stage that may include a sound production system 220 for conveying sound to a general audience. For example, the sound production system 220 may include one or more amplifiers for amplifying the performers' instruments or voices, and one or more speakers, horns, tweeters, or other high power transducers for converting electrical signals to acoustic signals. The sound production system 220 can also include multiple processors for adjusting one or more audio aspects of the sound produced. For example, the processors may include effects processors for adding reverb, delay, phase, flange, or other effects known in the musical industry. Moreover, the processors may include graphic equalizers, filters, or other sound processing devices for enhancing the sound quality or adjusting the sound. For example, a bass, mid-range, and treble of the sound can be controlled by the sound production system 220.

The performance 210 may include visual effects such as lighting to enhance a visual experience of the event. For example, a lighting system 230 may include one or more lighting elements to adjust a lighting of the performance. The lighting elements may change an intensity, a color, or a pattern of the visual effects in conjunction with the performance 210. The lighting system 230 may include high power lights, lasers, holograms, or other suitable lighting components. The lighting effects may also include fog machines or pyrotechnics to add visual effects to the lighting. For example, a fog machine can introduce fog during critical moments during the performance for adding excitement or illusion. The pyrotechnics can include fireworks or other suitable components for enhancing the visual experience of the performance. For example, high voltage sparklers or electronic flames can be used to generate visual cues in conjunction with the performance.

The performance 210 may also be a theatrical performance wherein certain behaviors or physical actions of the performers are captured and presented in visual form to the audience. A video production system 235 may be employed that captures one or more images or videos of the performance and presents the performance on one or more video screens. The video production system 235 may include one or more video cameras (not shown) for capturing footage of the event. The footage can be played on the video screens during the performance for allowing audience members to see the show. For example, during a solo performance, a zoom in video of the performer can be presented to the video screen for viewing by the audience.

The sound production system 220, the lighting production system 230, and the video production system 235, can be controlled by a central media console 250. The media console 250 can communicate with the various production systems to coordinate visual and audio effects with the performance 210. The media console system 250 may be a computer, a server, or any other suitable electronic system capable of coordinating performance activities. Briefly referring back to FIG. 1A, the media console 250 can also be communicatively coupled to the mobile communication system 100. For example, the media console 250 can be coupled to the server 130 for receiving multimedia messages from the one or more mobile devices 160.

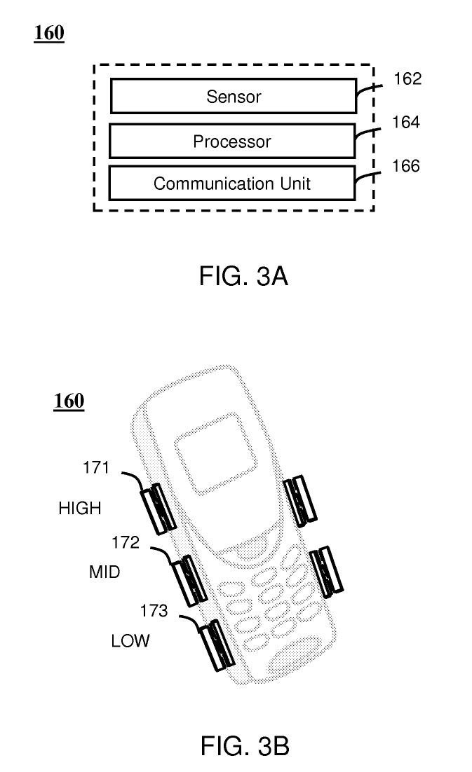

Referring to FIG. 3A, a schematic of the mobile device 160 for affecting a musical performance is shown. The mobile device 160 can include at least one sensor 162 for identifying a sensory action, a processor 164 communicatively coupled to the at least one sensor 162 for generating an evaluation, and a communication unit 166 for transmitting the evaluation. The processor 164 can associate a sensory action applied to the mobile device 160 with the performance and produce an evaluation of the performance in response to the sensory action. The evaluation addresses an audience member's response to the performance. The mobile device 160 may be a cell phone, a portable media player, a music player, a handheld game device, or any other suitable communication device.

Briefly, referring to FIG. 3B, the mobile device 160 can include a plurality of sensors 171-173 lined on a periphery of the mobile device 160. The sensors can be assigned to certain aspects of the performance. As one example, the sensors 171-173 may be designated for adjusting an audio aspect. Accordingly, the sensors 171-173 may be used for providing audio equalization. A top sensor 171 can be used for adjusting a treble, a middle sensor 172 can be used for adjusting a mid-range, and a bottom sensor 173 can be used for adjusting a bass. Understandably, the sensors as described are not limited to audio equalization. For example, the sensors can be used to adjust a lighting, wherein each sensor may control a color, an intensity, a hue, or a pattern. Notably, the sensors 171-173 allow audience members to squeeze the mobile device 160 for conveying an evaluation without having to look down at the device. For example, the users may be holding the device and watching the performance. The users, aware of the sensor assignments and associations with audio or visual aspects, can depress or squeeze the sensors to convey an evaluation based on physical touch alone. Moreover, the sensors are not limited to depressing actions. For examples, the sensors may be sliding sensors or scroll bars which allow a user to slide the sensor for affecting the performance. In another arrangement, the processor 164 may detect an intensity of location of a sensory action applied to the at least one sensor 162.

Furthermore, if so desired, a graphical user interface (GUI) resident on the mobile device 160 may also be referred to as a sensor and can be used for affecting the musical performance. The GUI may be controlled by one or more touchpads or keypads on the mobile device 160. The user can select a GUI corresponding to a sensory aspect of the performance. For example, an audio GUI can be deployed that presents a graphic equalizer for adjusting an equalization of the sound. A lighting GUI can be deployed that presents a visual aspect of the performance including colors, intensity, and hues. A video GUI can be deployed that presents visual perspectives or camera angles of the performance. An audience member can interact with the GUI to adjust the performance in a manner similar to the sensors.

Briefly, referring back to FIG. 2, the communication unit 160 can be communicatively coupled to the media console 250. Moreover, a plurality of mobile devices 160 can be communicatively coupled to the media console 250 for sending audience evaluations of the performance 210. The audience 240 can send multiple evaluations to the media console 250 over the mobile communications environment 100 of FIG. 1A. The media console 250 can receive the plurality of evaluations from an audience, associate the plurality of evaluations with a sensory aspect of the performance, and adjust a sensory aspect of the performance in accordance with the plurality of evaluations. The evaluations can be transmitted in the form of text messages, video messages, audio messages or the like. In one aspect, parameters of the sensory aspect can be communicated to the media console 250. For example, when the sensors 171-173 are utilized for an audio aspect, a level of the designated aspect can be conveyed via a message to the media console 250. For instance, graphic equalization levels can be specified in decibels or other units of volume. The media console 250 can receive the messages and adjust a sensory aspect of the performance in accordance with the parameters.

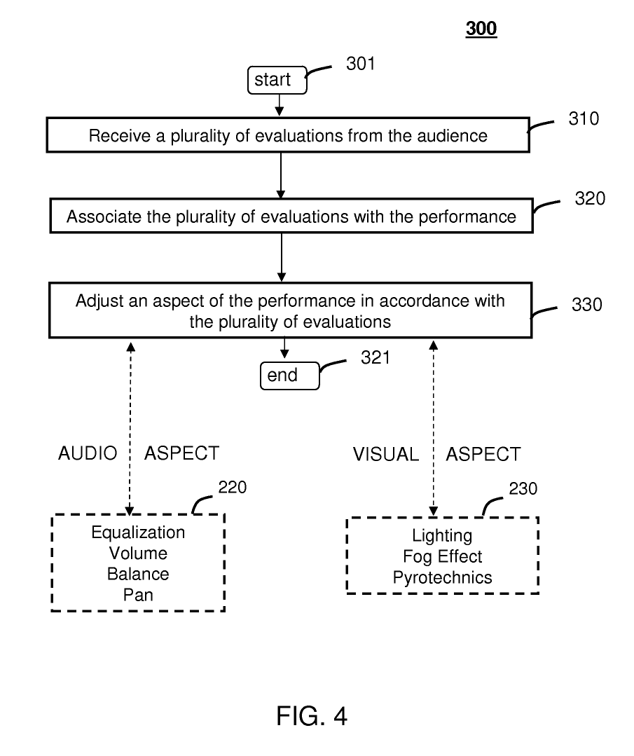

Referring to FIG. 4, a method 300 for affecting a musical performance is shown. The method 300 can be practiced with more or less than the number of steps shown. To describe the method 300, reference will be made to FIGS. 1A, 2, 3B and 4, although it is understood that the method 300 can be implemented in any other suitable device or system using other suitable components. Moreover, the method 300 is not limited to the order in which the steps are listed in the method 300 In addition, the method 300 can contain a greater or a fewer number of steps than those shown in FIG. 34

At step 301, the method 300 can begin. At step 310, a plurality of evaluations can be received from an audience. For example, referring back to FIG. 2, audience members in the audience 240 can utilize the mobile device 160 for conveying evaluations of the performance 210 to the media console 250. The evaluation conveys one or more interests of the audience member for adjusting a sensory aspect performance 210. For example, an evaluation may assess an audio aspect 220 or visual aspect 230 of the performance. The evaluation may describe a change to a sensory aspect of the performance, for example, such as increasing a volume, balance, or equalization of a performance. In practice, an audience member can interact with their mobile device during the performance 210 and propose an adjustment to one or more aspects of the performance 210 during the performance 210. Notably, the adjustment can occur in real-time; that is, the adjustment occurs during the performance 210. In particular, an audience member can squeeze the mobile device 160 at a particular location to change a sensory aspect of the performance 210, such as the audio equalization. For example, referring back to FIG. 3B, while listening to a musical performance, the audience member can squeeze various locations (171-173) of the mobile device 160 to elicit different effects.

At step 320, the plurality of evaluations can be associated with the performance. For instance, the evaluations can propose adjustments to an audio or visual sensory aspect of the performance. Referring to FIG. 2, the media console 250 can receive a plurality of evaluations from the audience and associate their evaluations with a sensory aspect of the performance. For example, the media console 250 can determine if the evaluations are directed to an audio aspect 220 or a visual aspect 230 or other sensory aspects. Referring back to FIG. 1A, the users can send messages containing one or more parameters of an aspect. For example, a message can include a change in the volume level or a change in the equalization. The message can be conveyed via circuit switched connections over the Radio Frequency link 110 or the WLAN link 150. For example, during a performance, a user squeezes a bottom portion of the mobile device 160 to increase bass content, squeezes the middle of the device to increase midrange audio, and squeezes the top to increase treble. A level indicating the adjustment can be included in the message. Understandably, extending this to a social situation, such as a concert, allows each individual to express (“vote”) their audio preference based on where they squeeze the device. Accordingly, the media console 250 and the live audio mix will be affected by the aggregated preferences. For example, if 60% want the bass increased, 20% want treble and 10% want midrange, then the audio output would be emphasized accordingly. Put another way, the audience becomes an organic “equalizer.”

As previously discussed, the embodiments are also directed adjusting a visual aspect of the performance such as lighting (selecting color and/or intensity), fog, pyrotechnics, and the like. Besides discrete areas, the mobile device 160 can also communicate a specific point along a range if so configured. For example, referring back to FIG. 3B, the sensors 171-173 can be sliding sensors such that sliding the pressure up and down the mobile device would cause the emphasis of the music to shift to a corresponding frequency or frequency band.

At step 330, an aspect of the performance can be adjusted in accordance with the plurality of evaluations. Notably, the evaluations convey the audience's collective adjustment to an aspect of the performance. The evaluations may specify values associated with one or more parameters such as an audio equalization or lighting intensity. Referring back to FIG. 2, the media console 250 can receive the plurality of evaluations from the audience 240. The media console 250 can interface with the sound production system 220, the lighting production system 230, and the video production system 235, or other sensory affecting systems such as scent, vibration, and motion. The media console 250 can direct one of the production systems to adjust an aspect of the performance in accordance with the received evaluations. For example, referring to FIG. 3B, the audience member can squeeze the mobile device 160 at different locations to propose changes a bass level or a treble level.

Notably, the media console 250 can assess the evaluations and adjust an aspect of the performance 210 in real-time during the performance. For example, the media console 250 can direct the sound production system 220 to adjust an equalization of the performance 210 in response to a collective response from multiple audience members. That is, the audience can provide collective feedback regarding their assessment of the performance, and propose changes to aspects of the performance. The collective feedback can be evaluated in real-time to determine changes to audio or visual effects of the performance 210. Notably, the media console 250 assesses multiple evaluations and changes an aspect in accordance with an audience-wide response. In one regard, the audience members cast a vote through their evaluations. The media console 250 assess the votes and adjusts an aspect of the performance in accordance with the majority vote.

Where applicable, the present embodiments of the invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present method and system may also be embedded in a computer program product, which comprises all the features enabling the implementation of the methods described herein and which when loaded in a computer system, is able to carry out these methods.

While the preferred embodiments of the invention have been illustrated and described, it will be clear that the embodiments of the invention is not so limited. Numerous modifications, changes, variations, substitutions and equivalents will occur to those skilled in the art without departing from the spirit and scope of the present embodiments of the invention as defined by the appended claims.

What is claimed is:

1. A method for affecting a performance, comprising:
during the performance,
receiving a plurality of evaluations from an audience;
associating the plurality of evaluations with the performance; and
adjusting a sensory aspect of the performance in accordance with the plurality of evaluations.

2. The method of claim 1, further comprising:
capturing a plurality of sensory actions from multiple devices handled by an audience;
generating the plurality of evaluations from the plurality of sensory actions; and
identifying a collective audience assessment of the performance from the plurality of sensory actions,
wherein the sensory action is a depressing action, a squeezing action, a sliding action, or a movement.

3. The method of claim 2, further comprising identifying a location and intensity of a sensory action on a device and adjusting the sensory aspect of the performance in accordance with the location.

4. The method of claim 1, wherein the identifying a collective audience assessment includes:
casting a vote for adjusting a sensory aspect of the performance based on the plurality of evaluations.

5. The method of claim 4, further comprising equalizing an audio performance in response to the vote, wherein the sensory actions adjust a bass, mid-range, or treble of the audio performance.

6. The method of claim 5, wherein the performance is an auditory experience such that the adjusting changes an equalization of sound produced during the performance.

7. The method of claim 4, further comprising adjusting a lighting of a visual performance in response to the vote.

8. The method of claim 7, wherein the performance includes a visual experience such that the adjusting changes a lighting, an intensity, an illumination, a color, a pattern, a fog effect, a pyrotechnic effect, or a strobe rate during the performance.

9. The method of claim 4, wherein the adjusting includes changing an olfactory experience.

10. The method of claim 9, wherein the olfactory experience includes increasing or decreasing a balance of scents.

11. The method of claim 4, wherein the adjusting includes changing a movement of objects in the performance.

12. A system for affecting a performance, comprising:
a device having,
at least one sensor for identifying a sensory action;
a processor communicatively coupled to the at least one sensor for associating the sensory action with the performance and producing an evaluation of the performance in response to the sensory action; and
a communication unit for transmitting the evaluation.

13. The system of claim 12, further comprising:
a media console,
communicatively coupled to the communication module for receiving a plurality of evaluations from an audience, associating the plurality of evaluations with an aspect of the performance, and adjusting a sensory aspect of the performance in accordance with the plurality of evaluations.

14. The system of claim 12, wherein the processor identifies at least one of a depressing action, a squeezing action, or a sliding action on at least one sensor.

15. The method of claim 12, wherein the processor identifies a location and intensity of the sensory action on the device.

16. The method of claim 13, wherien the processor adjusts one of an audio, visual, or olfactory experience for an audience.

17. A system for affecting a performance, comprising:
a plurality of mobile devices for
capturing a plurality of sensory actions applied to the plurality of mobile devices during a performance;
generating a plurality evaluations of the performance based on the plurality of sensory actions; and
sending the plurality of evaluations to a media console during the performance, wherein the sensory actions are audience responses to a sensory aspect of the performance, and,
a media console for
receiving the plurality of evaluations during the performance; and
assessing a collective experience of the audience in view of the plurality of evaluations.

18. The system of claim 17, further comprising:
associating the plurality of evaluations with a sensory aspect of the performance; and
adjusting the sensory aspect of the performance in accordance with the plurality of evaluations.

19. The method of claim 18, further comprising equalizing an audio performance in response to the evaluations, wherein the sensory actions adjust a bass, mid-range, or treble of the audio performance,
wherein the performance is an auditory experience such that the adjusting changes an equalization of sound produced during the performance.

20. The method of claim 18, further comprising adjusting a lighting of a visual performance in response to the evaluations,
wherein the performance includes a visual experience such that the adjusting changes a lighting, an intensity, an illumination, a color, a pattern, a fog effect, or a pyrotechnic effect during the performance.
